(19) United States
(12) Patent Application Publication
(10) Pub. No.: US 2026/0178052 A1
(43) Pub. Date: Jun. 25, 2026

(54) AUTOMATED SOLAR TABLE TRANSFER AND LANDING

(71) Applicant: Terabase Energy, Inc., Berkeley, CA (US)

(72) Inventors: James Christopher Deacon, Dallas, TX (US); Erik Robert Cummins, Davis, CA (US); Soren Jensen, Corte Madera, CA (US); Tyler Grushkowitz, Corvallis, OR (US); Adam Hansel, Davis, CA (US); Matthew Paul Campbell, Berkeley, CA (US)

(73) Assignee: Terabase Energy, Inc., Berkeley, CA (US)

(21) Appl. No.: 19/544,103

(22) Filed: Feb. 19, 2026

Related U.S. Application Data
(63) Continuation-in-part of application No. 18/991,103, filed on Dec. 20, 2024.
(60) Provisional application No. 63/690,797, filed on Sep. 4, 2024.

(51) Int. Cl. G05D 1/654; H02S 99/00

(52) U.S. Cl. CPC G05D 1/654; H02S 99/00

(57) ABSTRACT

In solar systems, the installation process for solar tables is typically implemented manually by an installer. Such a manual process negatively impacts cost-effectiveness and installation consistency, especially for large solar systems. The present invention discloses system and method embodiments of automatic solar table transfer from a solar table mobile transport to a lander vehicle for table landing. The lander vehicle determines a lander parking zone based on ambient 3D images, infrastructure information (e.g., solar table information), a transport parking zone of the mobile transport, and parameters of the lander vehicle. The lander vehicle may be controlled to autonomously park within the determined lander parking zone for solar table transfer and landing implementation. Therefore, the mobile transport may be configured with a simplified hardware structural focused on autonomous solar table delivery, while the lander vehicle may be designated for solar table fetching and landing.

### CROSS-REFERENCE TO RELATED APPLICATION

This application is a continuation-in-part of U.S. patent application Ser. No. 18/991,103 (Docket No. 20179-2714US), filed on Dec. 20, 2024, entitled “SYSTEMS AND METHODS FOR AUTOMATIC SOLAR TABLE LANDING AND SECUREMENT”, and listing Soren Jensen, Tyler Grushkowitz, Adam Hansel, and Matthew Paul Campbell as inventors, which claims the priority benefit under 35 U.S.C. § 119(e) to U.S. Provisional Ser. No. 63/690,797 , filed on Sep. 4, 2024, entitled “SYSTEMS AND METHODS FOR AUTOMATIC SOLAR TABLE LANDING AND SECUREMENT” and listing Soren Jensen as inventor. The aforementioned patent document is incorporated by reference herein in its entirety.

### TECHNICAL FIELD

The present disclosure relates generally to centralized assembly and installation of solar systems. More particularly, the present disclosure relates to systems and methods for automatic solar table landing and securement for improved transportation and installation efficiency.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is the cost-effective management of the construction process and the ability to move components around the site efficiently during the construction process.

Large-scale solar panel systems typically include thousands of solar panels that are located across a multi-acre terrain and that are electrically coupled to provide a source of energy. These large-scale systems are often located in remote areas and require a significant investment in materials, resources, and labor for installation and design. The sourcing and delivery of materials and resources for these installations can be problematic and inconsistent. A further complication is the reliable and safe movement of these materials and resources across large areas of the construction site as well as maintaining consistent installation processes at each point of installation within the site. These issues further contribute to an increase in the cost and complexity of a very cost-sensitive process.

FIG. 1 illustrates a typical prior-art installation process for solar systems. This prior-art installation process is implemented such that all mounting equipment for each solar panel is individually assembled and installed at its location within a large system. The cost-effectiveness of this approach works fine within smaller solar deployments but struggles to cost-effectively scale to large solar systems as described below.

This traditional deployment 101 relies on materials delivered to a deployment site via an access road. The materials are then processed and staged at the deployment site by a crew. A small portion of this delivered material is then moved by heavy equipment to a specific location where a solar panel and mounting equipment are assembled and installed at that location 102. The step is repeated for an adjacent location 103 where materials are subsequently delivered, assembled, and installed for a neighboring solar table within the system. While this approach may be effectively deployed in the installation of smaller solar systems, it becomes ineffective and cost-prohibitive as the size of the system increases.

What is needed are systems, devices, and methods that improve installation efficiency for large-scale solar panel systems.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 shows a prior art assembly and installation process of large-scale solar panel systems.

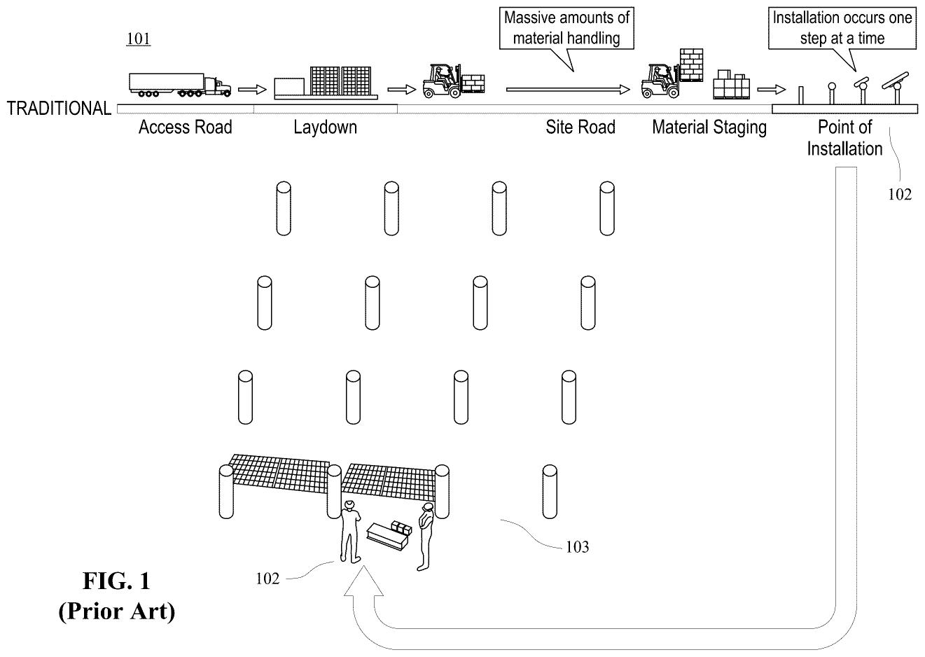

FIG. 2 is a diagram showing a centralized assembly and installation of a solar system including mobile transport of solar tables in accordance with various embodiments of the invention.

FIG. 3 is an exemplary sequence of diagrams illustrating an installation of a solar table within a solar system using a mobile transport according to various embodiments of the invention.

FIG. 4A is a perspective view of a solar table on a mobile transport according to various embodiments of the present invention.

FIG. 4B is a perspective view of a mobile transport unloading a solar table to a lander according to various embodiments of the present invention.

FIG. 5 is a close-up view of two ends of a torque tube according to various embodiments of the present invention.

FIG. 6 is a system view for automatic solar table landing and securement according to various embodiments of the present invention.

FIG. 7 is a perspective view of a torque tube aligned to a torque tube of a previously installed solar table and secured to a pile according to various embodiments of the invention.

FIG. 8 is a process diagram for automatic solar table landing and securement for torque tubes having swaged and unswaged ends according to various embodiments of the invention.

FIG. 9A is a schematic view of two torque tubes connected via a tube coupler according to various embodiments of the invention.

FIG. 9B is a schematic view of two polygon torque tubes connected via a polygon tube coupler according to various embodiments of the invention.

FIG. 10 is an alternative process diagram for automatic solar table landing and securement according to various embodiments of the invention.

FIG. 11 is another alternative process diagram for automatic solar table landing and securement according to various embodiments of the invention.

FIG. 12 is a perspective view of a lander unloading a solar table from a mobile transport at a point of installation according to various embodiments of the present invention.

FIG. 13 is a progress diagram of a lander unloading a solar table at a point of installation from a mobile transport that arrives first according to various embodiments of the present invention.

FIG. 14 is a perspective view of a lander parking at a point of installation awaiting a mobile transport according to various embodiments of the present invention.

FIG. 15 is a progress diagram of a lander vehicle at a point of installation, awaiting a mobile transport, and unloading a solar table from the mobile transport according to various embodiments of the present invention.

FIG. 16 shows a simplified block diagram of a computing system in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion, components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components. Components may be implemented in a variety of mechanical structures supporting corresponding functionalities of the solar table mobile transport.

Furthermore, connectivity between components or systems within the figures is not intended to be limited to direct connections. Also, components may be integrated together or be discrete prior to the construction of a solar panel mobile transport.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functions may be optional; (2) components or functions may not be limited to the specific description set forth herein; (3) certain components or functions may be assembled/combined differently across different solar table mobile transports; and (4) certain functions may be performed concurrently or in sequence.

Furthermore, it shall be noted that many embodiments described herein are given in the context of the assembly and installation of large numbers of solar tables within a system, but one skilled in the art shall recognize that the teachings of the present disclosure may apply to other large and complex construction sites in which resources and personnel are difficult to manage and accurately predict. Additionally, embodiments of a solar table rack may be used in smaller solar farm construction sites.

In this document, “large-scale solar system” refers to a solar system having 1,000 or more solar panels. The word “resources” refers to material, parts, components, equipment or any other items used to construct a solar table and/or solar system. The word “personnel” refers to any laborer, worker, designer, or individual employed to construct or install a solar table or solar system. The term “solar table” refers to a structural assembly comprising a torque tube and/or purlins with module rails. Some types of solar tables may have supplemental structure that allows them to connect to foundations/piles, while other types do not have this supplemental structure. A solar table may have (but is not required) one or more solar panels and/or electrical harnesses. The term “solar table mobile transport” (hereinafter, “mobile transport”) describes a vehicle that facilitate the transportation from the point of assembly to the point of installation. The mobile transport may also be configured to implement solar table installation. A mobile transport may be driven by personnel, controlled by remote control or move autonomously within at least a portion of a solar system construction site. The term “transport component” refers to a lower portion of the mobile transport that provides movement and includes wheels (or similar features such as tracks, a tractor assembly or robotic system), steering mechanism (autonomous or personnel driven) and braking mechanism.

In this document, the “motor” is defined as a structural device that produces motion, unidirectional or multidirectional, of a solar table. Examples of some motors may include elements such as actuators, tracks, etc. that help in producing motion of structures within the mobile transport or the solar table.

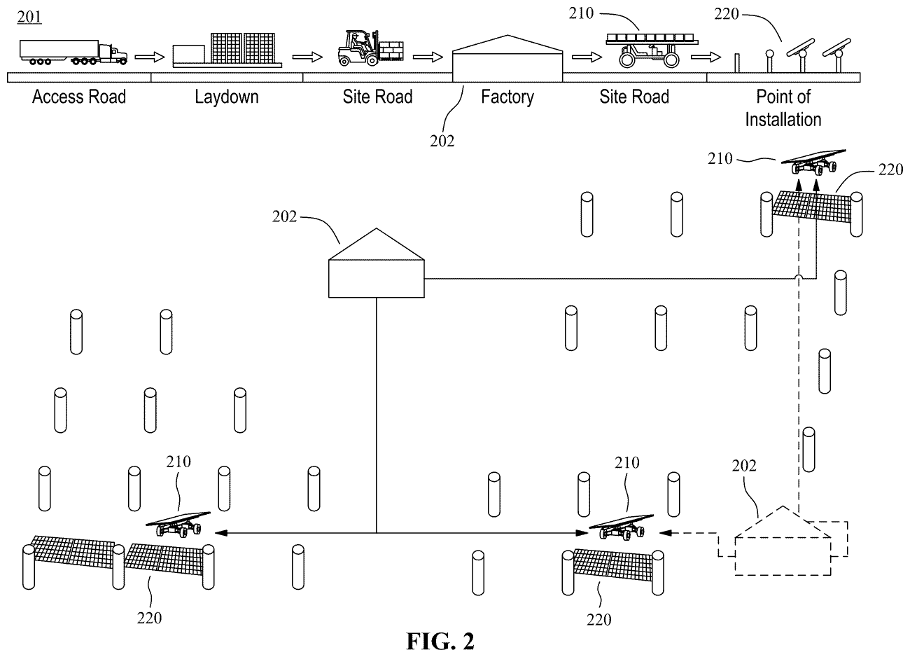

FIG. 2 provides an overview of a centralized solar table assembly and installation for large-scale solar systems according to various embodiments of the invention. Embodiments of the invention transition the traditional approach of distributed assembly and installation at single location sites to a centralized and coordinated assembly factory that allows a more cost-effective and dynamic process of constructing large-scale solar systems. This centralized assembly of solar system components, such as solar tables, necessitates a more robust transport vehicle to move the preassembled components to the installation site.

Resources are brought to construction site 201 for a large-scale solar system and initially processed. These resources are delivered to one or more assembly factories 202 where a coordinated and centralized solar table assembly process is performed. In certain embodiments, a construction site may have multiple centralized factories 202. The location and number of centralized factories 202 may depend on several parameters, including the size of the site, the terrain of the site, the design of the site, and other variables that relate to the construction of the large-scale solar system. Solar tables may be preassembled at a centralized factory 202 and transported to a point of installation 220 via motorized vehicles 210.

Assembled solar tables and equipment are moved from factory 202 to a point of installation 220 via motorized vehicles 210, such as a mobile transport that might or might not have side shift or any actuation capabilities. In most situations, mobile transports have the ability to lift the solar table above the adjacent already installed tables. In certain embodiments, the mobile transports are specifically designed to transport solar tables along a site road to the point of installation 220. As previously mentioned, the mobile transports 210 may be driven by personnel, may be controlled by remote control, or autonomously driven by a computer system using GPS, Lidar, and/or cameras combined with infrastructure information about the solar power plant, e.g., pile and table locations and access road etc. The time and/or sequence in which solar tables are delivered to points of installation 220 may depend on various factors that may be analyzed to configure a preferred schedule.

Delivery of an assembled solar table to an installation site requires an alignment process to secure points at the installation site. Because an assembled solar table is often large and heavy, this alignment process may be difficult and require significant manual effort by personnel to properly align both ends of a solar table to receptors, piles, or other coupling elements at the installation site.

### A. Embodiments of Automatic Solar Table Landing

Described hereinafter are systems and methods for automatic solar table landing and securement for improved transportation and installation efficiency. The solar table mobile transport or a specific lander vehicle may be controlled to allow motorized and automatic alignment of the solar table while it is still secured to the mobile transport. As a result, installation efficiency may be significantly improved.

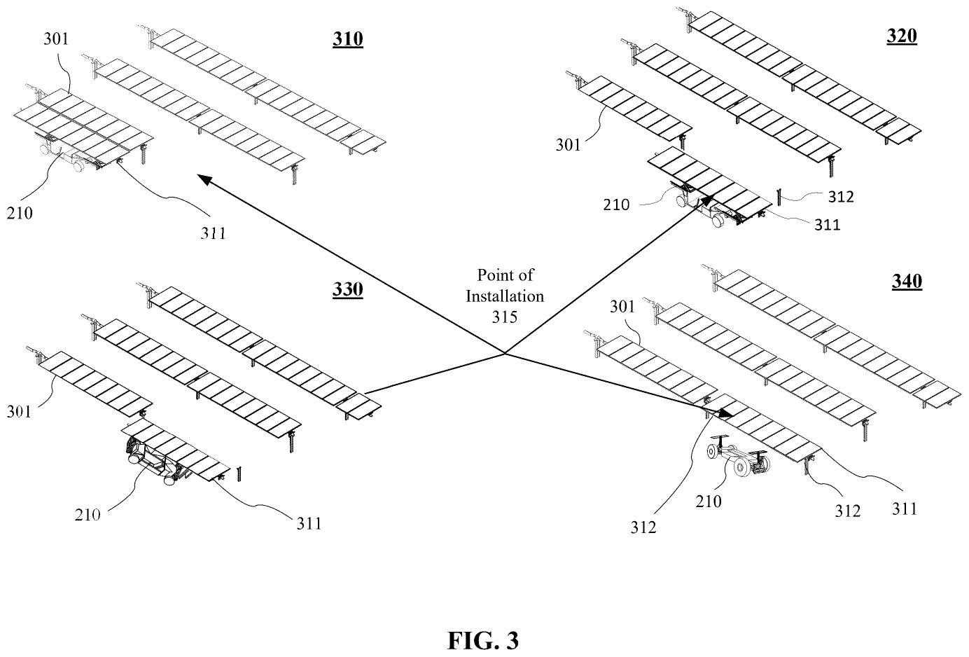

FIG. 3 illustrates a sequence of installation steps for a solar table at an installation site using a solar panel mobile transport with sideshift capability according to various embodiments of the invention. As shown in 310, a mobile transport 210 supporting a solar table 311 approaches a point of installation 315. The solar table 311 is secured to the mobile transport 210 by a solar table attachment component that securely holds the solar table above the mobile transport 210 (or the lander vehicle 410). In certain embodiments, the solar table 311 is assembled and secured to the attachment component at a centralized assembly factory and subsequently driven to the point of installation 315.

As shown in 320, the mobile transport 210 approaches the point of installation 315 in preparation for installation within the solar system. Mobile transports with sideshift can land the solar table from the offset position shown in 320 and 330. The point of installation 315 comprises structures used to secure the solar table 311 within the system. For example, a solar table 311 may be secured to a previously installed table 301 whereby a torque tube in the solar table 311 is aligned and inserted into a torque tube of the previously installed table 301. The solar table 311 may need to be secured to a pile 312 where threaded fasteners/rivets connect its bearing housing assembly/brackets to the pile 312.

As shown in 330, the mobile transport 210 aligns the solar table 311 at the point of installation 315 for subsequent integration into the solar system. This alignment process may be an automatic process and will be discussed in more detail below.

As shown in 340, the solar table is secured within the solar system after alignment is completed. This securement process may also be an automatic process and include attaching the solar table 311 to the pile 312 that locks the solar table in line with the previously installed table 301. Afterward, the mobile transport 210 detaches from the solar table 311 and may leave the point of installation 315 to go back to the centralized factory 202.

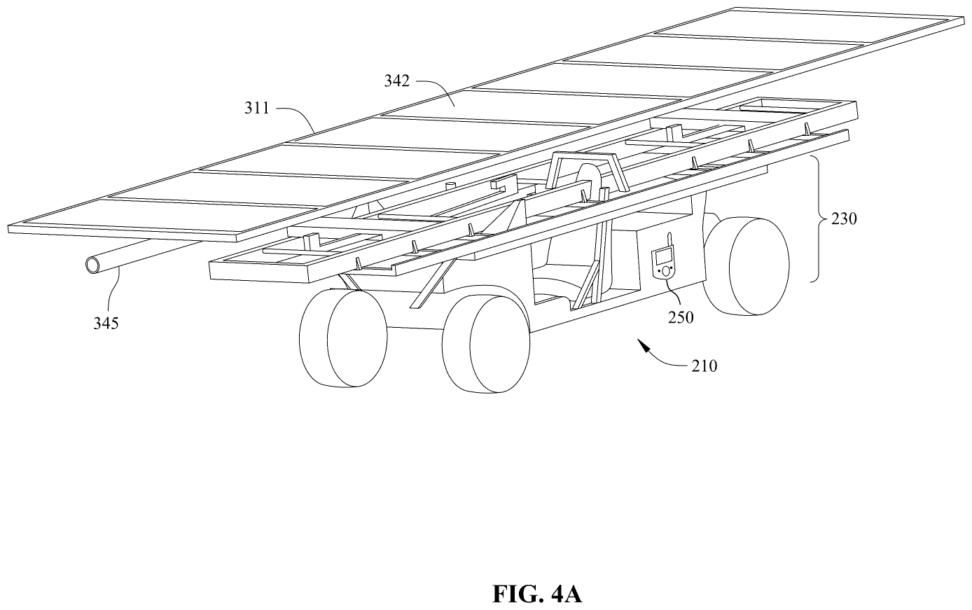

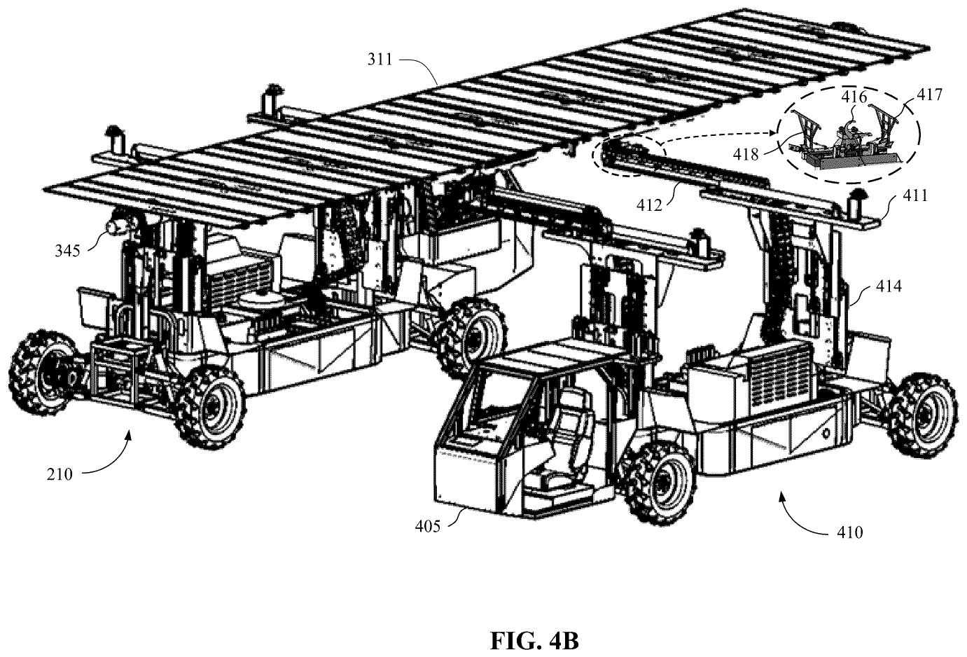

FIG. 4A is a perspective view of a solar table 311 on a mobile transport 210 according to various embodiments of the present invention. The solar table 311 comprises one or more solar modules 342 securely attached to a torque tube 345. This mobile transport 210 comprises a transport component 230 that can securely move the solar table 311 to an installation point. The mobile transport 210 may comprise components to allow a dynamic alignment process for a torque tube 345 of the solar table 311 at the installation site. This mobile transport 210 may further comprise a Global Positioning System (GPS) receiver 250 to record a GPS coordinate of the mobile transport 210 at various locations, such as an installation location where the mobile transport 210 arrives to unload the solar table 311 for installation.

The transport component 230 comprises a vehicular segment that can move throughout a solar system construction site under the control of a driving system. Examples of the vehicular segment include a wheel system, tractor system and/or robotic movement system to move a solar table from a factory to an installation point. The transport component 230 comprises a driving system that effectively controls the movement of the mobile transport as it carries a solar table from a centralized factory to an installation site. The driving system may comprise various sensors, e.g., camera(s), light detection and ranging (LIDAR) sensor(s), and/or ultrasonic distance sensor(s) to allow autonomous driving.

In one or more embodiments, the mobile transport 210 may handle both transporting and installing of the solar table 311. Alternatively, the mobile transport 210 may only deliver autonomously the solar table on-site without or having limited articulation or side-shift capability to lift the table above existing installed tables to avoid collision and/or to help facilitate ease of transfer of the solar table to the Lander. Instead, a dedicated lander vehicle, also referred to as a lander, picks the solar table 311 from the mobile transport 210 directly or from where the mobile transport 210 drops the solar table 311 for installation. The lander has appropriate articulation and side-shift capabilities. Therefore, the automatic solar table landing and installation may be performed by the mobile transport, a lander, or a combination of both.

FIG. 4B is a perspective view of a mobile transport unloading a solar table to a lander according to various embodiments of the present invention. The lander 410, which picks up solar table 311 from the mobile transport 210 directly or from where the mobile transport 210 drops the solar table 311 for installation. The lander 410 comprises a base vehicle 405 to provide movement, a pair of support rails 411, a pair of sliding rails 412 slidably attached to respective support rails, a pair of vertical motion elements 414 attached to the base vehicle to enable vertical motion of support rails 411. A tube hook 416 may be deployed on each sliding rail 412 to hold the torque tube 345 of the solar table 311 securely during the fetching or installation process. A pair of anti-rotational wings 417/418 may be placed on both sides of the tube hook 416 to provide stable and secure support for the corresponding solar table during the fetching or installation process. After the lander 410 takes possession of the solar table 311, the mobile transport 210 returns to the factory to pick up a new solar table. After the lander 410 completes the installation of the solar table 311, the lander 410 moves to a new point of installation associated with the next solar table. It shall be noted that the mobile transport 210 and the lander may be identical as shown in FIG. 4B, or they may be different with the mobile transport having no or limited articulation of the table support. For example, the mobile transport 210 may be a trailer that is towed by a powered vehicle, e.g., an all-terrain vehicle (ATV) or a utility task vehicle (UTV), for hauling one or more assembled solar tables. The trailer may have a solar table positioning system that lifts a solar table 311 above ground piles and possibly shifts the solar table sideways to facilitate solar table transferring to the landing vehicle 410.

In another embodiment, the lander 410 may pick up a solar table directly at the factory and transport it to the point of installation and complete the installation before returning to the factory to pick up the next table. In this embodiment, the lander 410 may perform both tasks of solar table transporting from the factory and solar table installing on-site.

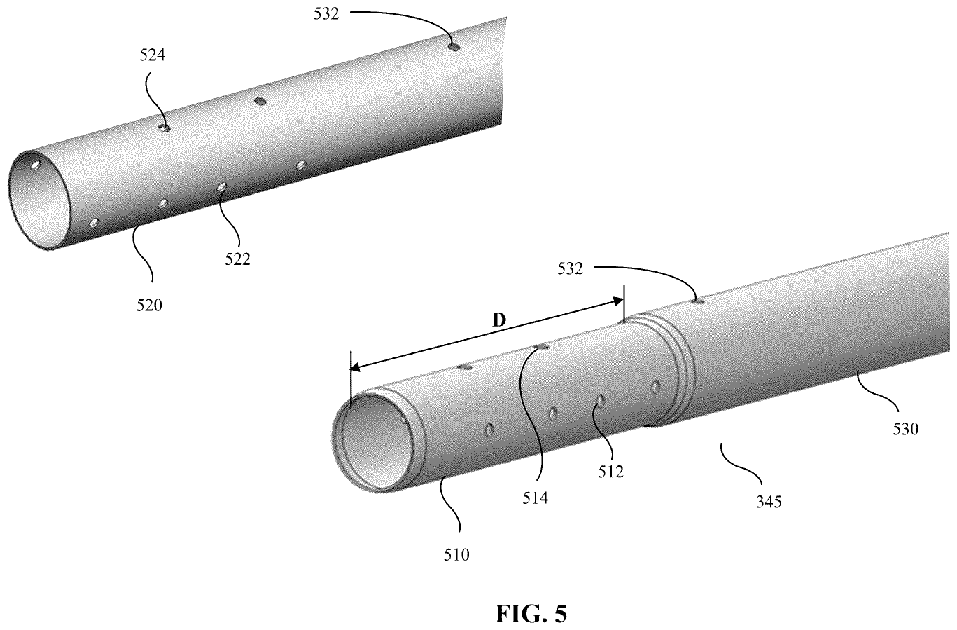

FIG. 5 is a close-up view of two ends of a torque tube according to various embodiments of the present invention. The torque tube 345 comprises a first tube end 510 for tube installation on supporting piles, a second end 520 (shown side-by-side of the first tube end 510 for a close-up view), and a tube body 530 that comprises multiple bracket holes 532 that are typically aligned and uniformly spaced for bracket installation. Each bracket hole 532 is used to attach a bracket that engages a module frame of a solar module.

The first tube end 510 is also referred to as a swaged end with a diameter smaller than the diameter of the tube body 530. The second end 520, which is the opposite end of the swaged end, has the same diameter as the diameter of the tube body 520 and is referred as an unswaged end. The torque tube may have a known distance D for the length of the swaged end. Such a known distance D may be used to align two torque tubes. The first tube end 510 has multiple end holes 512 with a pattern matching end holes 522 on the second tube end 520. Such a matching pattern requires a perfect alignment and connection between two torque tubes.

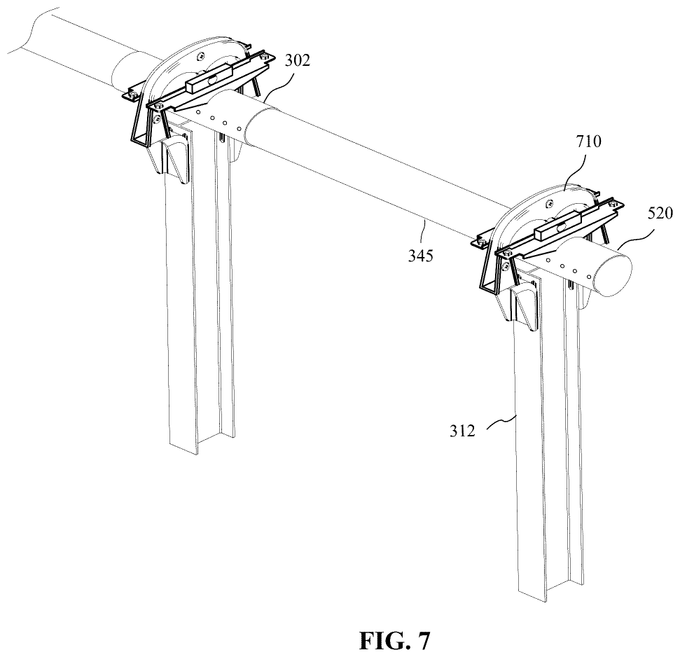

In one or more embodiments, the torque tube 345 may further comprise multiple alignment holes 514/524 disposed on the first tube end 510 and the second tube end 520. The alignment holes are for placing bearing housing assembly (BHA) (e.g., the BHA 710 shown in FIG. 7) installation such that the torque tube 345 may be rotatably secured onto a supporting pile. The alignment holes on the first tube end and the second tube end may have a matching pattern, e.g., inter-hole distance and hole-edge distance, for coupling alignment between two torque tubes. For example, a torque tube may have its swaged end inserted into an unswaged end of a previously installed torque tube with the alignment holes 514/524 of both tubes aligned for jointly secured by a BHA onto a support pile.

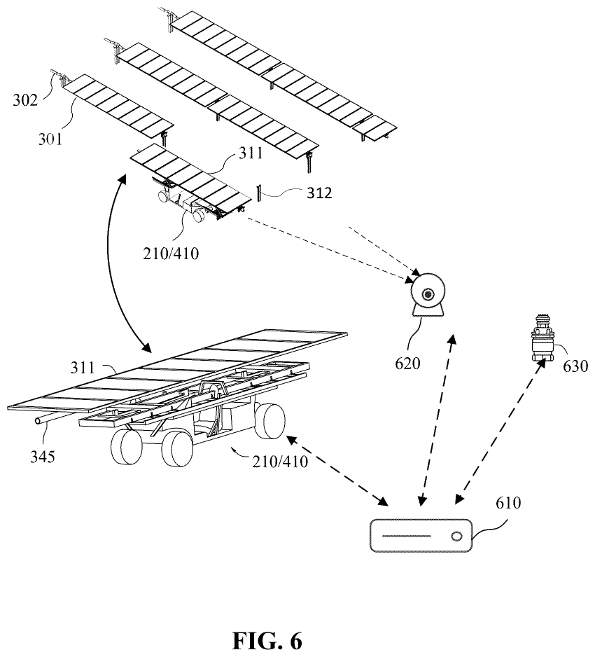

FIG. 6 is a system view for automatic solar table landing and securement according to various embodiments of the present invention. The system comprises the mobile transport 210 (or a lander 410), one or more cameras 620 (or LIDAR sensors), one or more proximity sensors 630 (e.g., ultrasonic proximity detectors), and a controller 610 coupled to the mobile transport 210 (or the lander 410), the one or more cameras 620, and the one or more proximity sensors 630. The controller 610, the one or more cameras 620, and the one or more proximity sensors 630 may all be integrated into the mobile transport 210 (or the lander 410). Additionally, the mobile transport 210 (or the lander 410) may comprise one or more load sensors and/or proximity sensors, which may be used to monitor whether the solar table 311 is unloaded from the mobile transport.

When the mobile transport 210 (or the lander 410) arrives at the point of installation 315, the one or more cameras 620 capture ambient images around the point of installation 315 for the controller 610 to identify and locate a previously installed solar table 301 for table alignment and a pile 312 for table landing. The information to be gathered for the torque tube 302 of the previously installed solar table 301 includes x, y, and z coordinates of the intersection of a vector going through a set of rivet/bolt holes and a vector going through the centerline of the tube 302. Similar information is also needed for the swaged section as well. An optical or mechanical method to ensure final alignment of the bolt/rivet hole patterns may also be implemented as an option.

The controller 610 controls the mobile transport 210 (or the lander 410) to automatically maneuver into a desired parking position for table landing, with the help of the cameras 620 and the proximity sensors 630. The mobile transport 210 (or the lander 410) then aligns the solar table 311 to the previously installed solar table 301 and the pile 312. The mobile transport 210 (or the lander 410) may park offset from the pile line, and be controlled to raise, lower, tilt, roll, rotate, and/or sideshift the solar table 311 into an aligned position.

The aligning and landing of the solar table is monitored using feedback from one or more load sensors or proximity sensors (e.g., magnetic/Hall effect, Inductive/capacitive/eddy current sensors, optical visible or infrared sensors, magneto-resistive sensors or ultrasound sensors, etc.) deployed on the mobile transport and ongoing images captured from one or more cameras or LIDAR sensors deployed on the mobile transport. The whole installation process may be improved through machine learning and AI to manage the multitude of combinations of variables and conditions that may require corrective action. In one or more embodiments, the AI model may be trained in various training settings, e.g., different solar farms with various pile configurations, for feature recognition. The AI may be deployed on the mobile transport 210 (or the lander 410) that is also subject to manual control such that the AI model may be trained to follow the manual operation, or may generate simulated controls for comparison to actual manual controls for AI model control parameters tunning.

FIG. 7 is a perspective view of a torque tube aligned to a torque tube of a previously installed solar table and secured to a pile according to various embodiments of the invention. Solar modules are not shown in FIG. 7 for the purpose of a transparent perspective view of the torque tubes. The torque tube 345 of the solar table 311 is engaged to the torque tube 302 of the previously installed solar table 301 (for figure clarity, only torque tubes 302 and 345 shown in FIG. 7) with the swaged end of the torque tube 345 inserted into the unswaged end of the torque tube 302, and holes overlaid for securing. Furthermore, the torque tube 345 is landed and supported by the pile 312 with a bearing housing 710 aligned and placed on the pile 312 to secure the torque tube 345.

It shall be noted that the solar table 311 may be installed at a point of installation without a previously installed solar table to align. For example, the solar table 311 may be the first to be installed in a row. In this circumstance, the mobile transport 210 needs to align/land the solar table 311 with two supporting piles for securement. For example, the torque tube of the solar table 311 may have one end inserted in a slew drive tube and a back end landed on the next pile. Subsequent solar tables may have their torque tubes installed similarly.

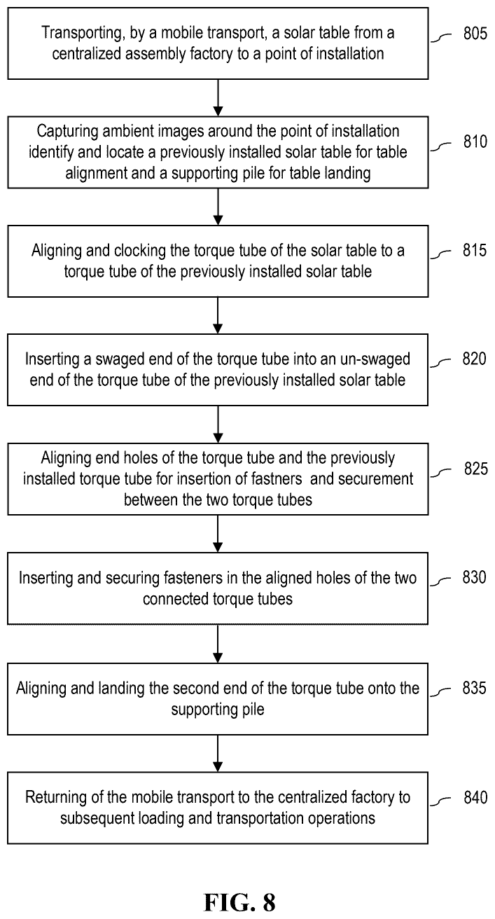

FIG. 8 is a process diagram for automatic solar table landing and securement according to various embodiments of the invention. In step 805, a solar table is loaded onto a mobile transport for transportation from a centralized assembly factory to the point of installation. The point of installation may be associated with a pile or a pair of piles to support the solar table, with each pile having predetermined geographic information, such as a GPS coordinate or local geographical information (e.g., a row number and a column number for the pile among all piles within the solar farm). In one or more embodiments, the predetermined geographic information may be available in a solar system infrastructure database, e.g., a local or a cloud database, and accessible by authorized personnel. The point of installation may also be determined automatically by an algorithm in a Manufacturing Execution System (MES).

In step 810, ambient images, e.g., camera images or LIDAR images, around the point of installation are captured to identify and locate a previously installed solar table for table alignment and a supporting pile for table landing, or to locate a pair of supporting piles for table landing if there is no previously installed solar table for alignment.

In step 815, the torque tube of the solar table is aligned and clocked to a torque tube of the previously installed solar table (also referred to as a previously installed torque tube). This step may involve automatic maneuver of the mobile transport into a parking position for alignment of the torque tube and insertion of the first end (swaged end) of the torque tube into the unswaged end of the torque tube of the previously installed solar table. The alignment step may involve using 3D images collected with said LADAR/camera(s) to identify the end of the previously installed torque tube, the end of the solar table on the mobile transport/lander and the pile on which the back end of the table being landed will be placed on. AI-based imaging processing model may be used to recognize the end of the position and orientation of the installed torque tube, the position and orientation of the end of the table to be landed, as well as the pile on which the back end of the table will be landed on.

In step 820, a swaged end of the torque tube of the solar table to be installed in inserted into an unswaged end of the torque tube of the previously installed solar table.

In step 825, end holes of the torque tube and the previously installed torque tube are aligned for insertion of fasteners and securement between the two torque tubes. The fasteners may be pull rivets, threaded fasteners, or other fastening methods. In one or more embodiments, mechanical verification may be performed after the alignment and clocking of the torque tube of the solar table.

In step 830, fasteners are inserted into the aligned holes and secured to connect the two torque tubes together.

In step 835, the second end (unswaged end) of the torque tube is aligned and landed onto the supporting pile with a bearing housing placed on the supporting pile to secure the torque tube, and thus the solar table.

In step 840, the mobile transport unloads the solar table and returns to the centralized factory for subsequent loading and transportation operations. The unloading of the solar table from the mobile transport may be monitored via one or more load sensors (e.g., pressure sensors or proximity sensors) deployed on the mobile transport determining the presence of a solar table on the mobile transport.

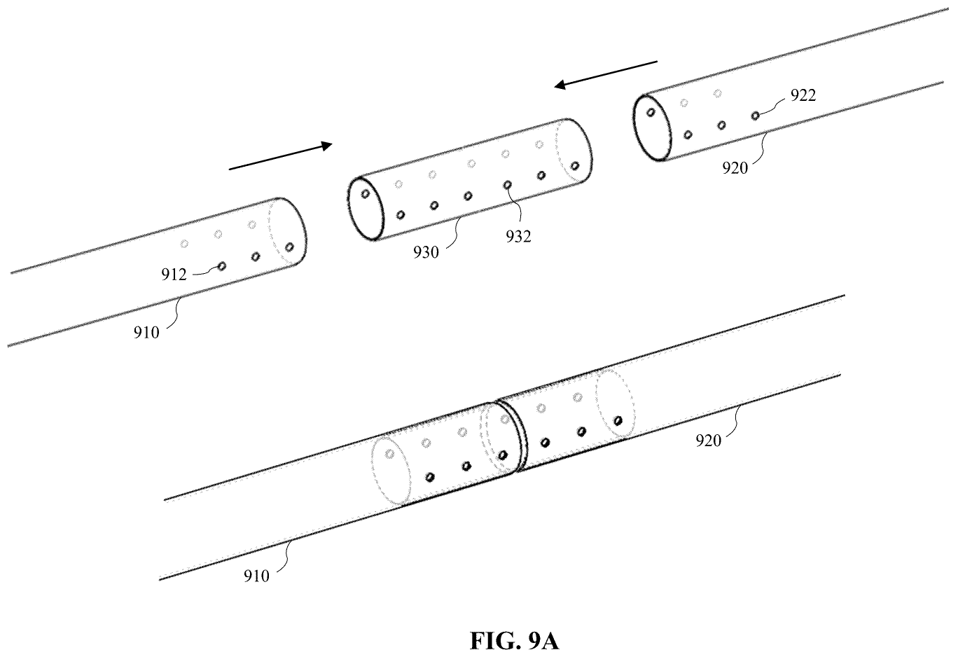

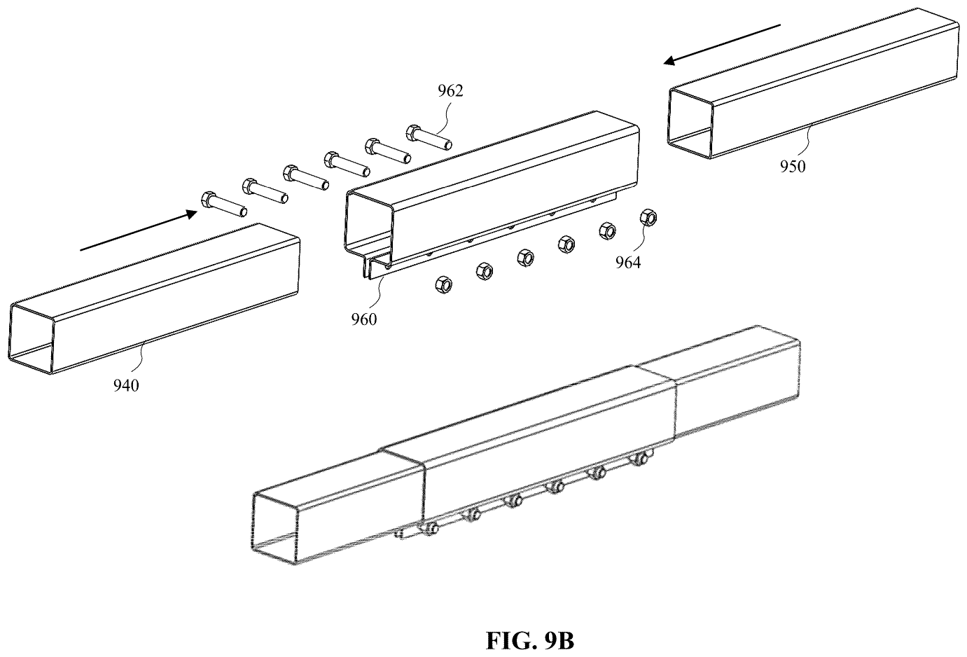

In one or more embodiments, certain torque tubes may not have a swaged end and unswaged end. To implement connections between those torque tubes, a tube coupler is needed. FIG. 9A is a schematic view of two torque tubes 910 and 920 connected via a tube coupler 930 according to various embodiments of the invention. The first torque tube 910 has a first end comprising multiple end alignment holes 912. Similarly, the second torque tube 920 has a second end comprising multiple end alignment holes 922. The tube coupler 930 may be a linear insert that is inserted into the torque tubes 910 and 920. The linear insert comprises a plurality of coupling alignment holes 932 to match the end alignment holes 912/922 such that the torque tubes 910 and 920 can be securely connected via the linear insert. Connection between the torque tube and a supporting pile may be realized through a Bearing Housing Assembly (BHA) that allows rotation of the torque tube but no lateral or horizontal movement, except some in the North-south direction.

Alternatively, the tube coupler 930 may be a sleeve to connect the torque tubes 910 and 920. The sleeve may be a one-piece component, or comprise multiple pieces jointed together to function as a coupler. For example, the sleeve may comprise an upper cover and a lower cover to be bolted or threaded together as a sleeve. Such variations shall be within the scope of the present disclosure.

FIG. 9B is a schematic view of two polygon torque tubes 940 and 950 connected via a polygon tube coupler 960 according to various embodiments of the invention. The polygon tube coupler 960 couples one end of the first polygon torque tube 940 to a corresponding end of the second polygon torque tube 950, and securely holds both tubes together via a plurality of bolts 962 and nuts 964, which are tightened after both tubes are in desired positions. In this configuration, alignment holes on the tubes/coupler may not be needed for secure tube coupling.

Although the coupler 960 showing in FIG. 9B has a one-piece sleeve configuration, one skilled in the art shall understand that various other configurations, e.g., a two-piece design, may also be applicable for coupling the torque tubes together. The polygon tube coupler may have a cross-sectional profile of a square, a rectangle, a hexagon, an octagon, etc., to couple various polygon torque tubes.

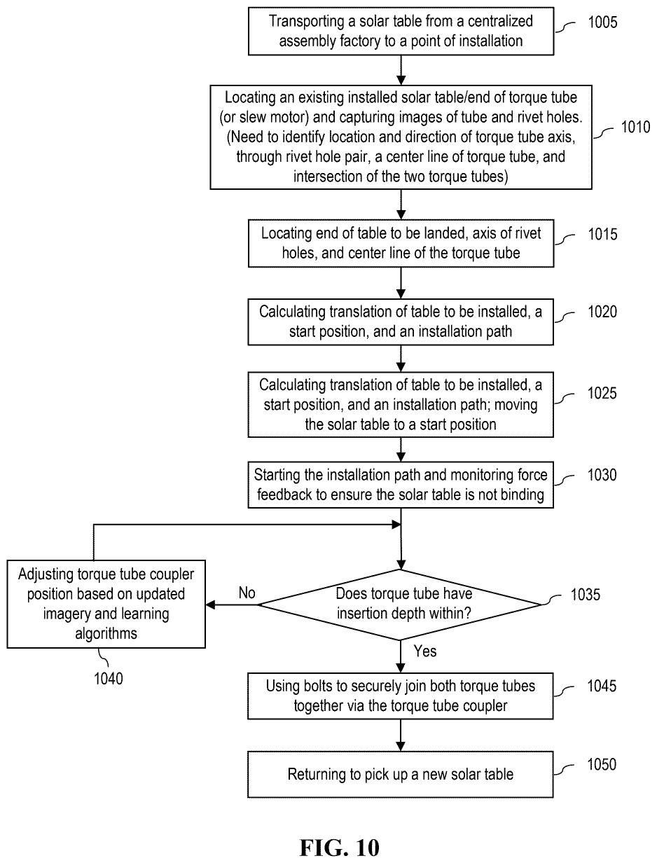

FIG. 10 is an alternative process diagram for automatic solar table landing and securement according to various embodiments of the invention. In step 1005, a solar table to be landed is transported by a mobile transport from a centralized assembly factory to a point of installation. The solar table comprises a torque tube and multiple solar modules secured onto the torque tube. Depending on the type of the torque tube, a tube coupler may be pre-installed onto the torque tube. Alternatively, the tube coupler may be installed onto the torque tube after the solar table is landed onto supporting pile(s) or be installed when two torque tubes are coupling together. The mobile transport may perform solar table installation once it arrives at the point of installation or drop the solar table to a lander and return it to the centralized assembly factory to load another solar table.

In step 1010, a torque tube end of a previously installed solar table (or a slew motor) is located, and images of the torque tube end and modules are captured. In one or more embodiments, the location and direction of the torque tube, an intersection between a center line of the torque tube and solar module edges are also identified. In other words, both the axis of the previously installed torque tube and the end of the torque tube are identified. The rivet holes on the end of the installed torque tube are also located and used for alignment purposes.

In step 1015, a torque tube end of the solar table to be landed, axis of the solar modules on the solar table, and a center line of the torque tube of the solar table to be landed, an intersection between the center line and the axis of the solar modules are located. In this step, the center axis of the torque tube on the solar table to be landed is located as well as the end of the torque tube including the rivet holes. The rivet holes are used for determining the solar table roll and the distance between the two solar tables as the landing process is progressing. One critical step is to align the two axes of the torque tube ends of the two solar tables to be joined. In one or more embodiments, only the last 3-4 feet of a torque tube is considered for determine the axis of the torque tube, due to possible curvature along the overall length of the torque tube due to the load of multiple solar modules. In step 1020, translation of the solar table to be landed, start position, and installed installation path, and move-to-start position are calculated, and the solar table to be landed is moved, by the mobile transport via horizontal/vertical movement, to a start position.

In step 1025, alignment path is started to align, via pitch/roll/yaw adjustment, the solar table to be landed with the previously installed solar table. The alignment may be implemented in N-S direction with a space between the torque tube end of the previously installed solar table and the torque tube end of the solar table to be landed.

In step 1030, the torque tube of the solar table to be landed is slid toward the previously installed solar table, or the tube coupler is moved into a place overlapping both ends of the adjoining torque tubes. In step 1035, the insertion depth within the tube coupler is checked against a predetermined depth. In response to not having enough insertion depth, the process goes to step 1040, in which a position of the tube coupler is adjusted based on updated imagery and learning algorithms.

In step 1045, in response to having enough insertion depth, the torque tube coupler is tightened using bolts to securely join both torque tubes together to finish landing of the solar table. In step 1050, the mobile transport returns to the centralized factory after the offloading of the solar table for subsequent loading and transportation operations; after completing the table installation, the lander moves to the next point of installation to perform a subsequent solar table picking and installing.

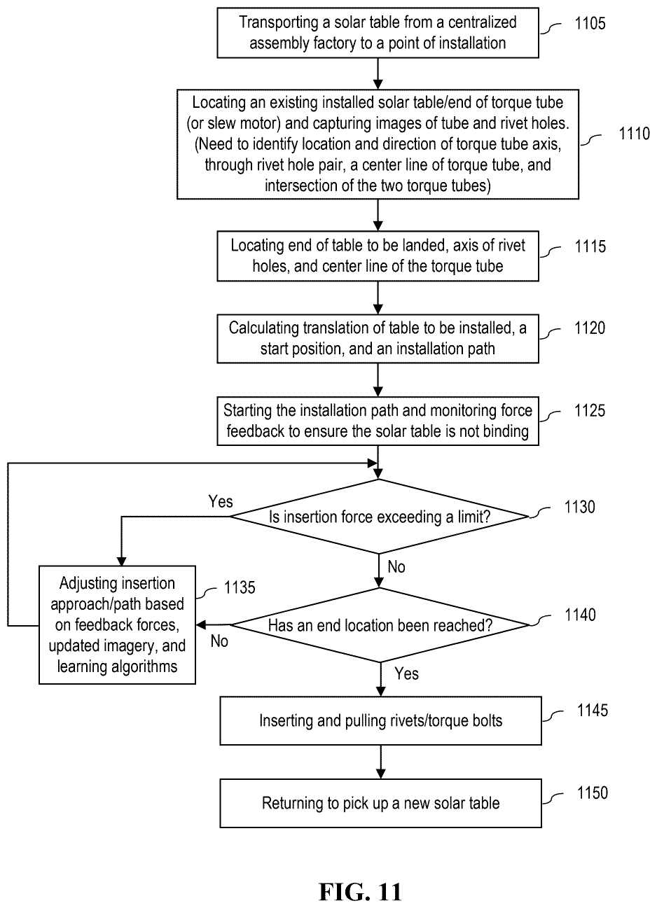

FIG. 11 is another alternative process diagram for automatic solar table landing and securement according to various embodiments of the invention. In step 1105, a solar table is loaded onto a mobile transport for transportation from a centralized assembly factory to a point of installation. The solar table comprises a torque tube and multiple solar modules secured onto the torque tube. In step 1110, an installed solar table or an end of torque tube (slew motor) are located with images of the torque tube and rivet holes captured by one or more cameras or LIDAR sensors deployed on the mobile transport. In one or more embodiments, this step also involves identifying the location and direction of a torque tube axis of the installed solar table through rivet hole pair, a center line of the torque tube, and an intersection of two torque tubes.

In step 1115, the end of the solar table to be landed, the axis of rivet holes, and the center line of the torque tube are located. In step 1120, a translation of the solar table to be installed, a start position, and an installation path are calculated. In step 1125, the installation path is started with force feedback monitoring to ensure the solar table is not binding. The monitored force may be referred to as an insertion force that is applied to the torque tube of the solar table to be installed to initiate an insertion motion of the torque tube into a coupler or a corresponding end of an installed torque tube.

In step 1130, the insertion force is compared to a limit for insertion force verification. In step 1135, in response to the insertion force exceeding the limit, the insertion path is adjusted based on feedback from the insertion force, updated imagery, and learning algorithms. Afterward, the process goes back to step 1130 for insertion force verification again.

In step 1140, in response to the insertion force not exceeding the limit, a verification is made regarding whether an end location has been reached. The end location is the designated position of the torque tube of the solar table to be installed at the end of the insertion motion. In response to the end location not being reached, the process returns to step 1135 for recalculating the insertion path.

In step 1145, responsive to the end location being reached, rivets or torque bolts are installed to securely lock the torque tube of the solar table to be installed at the end location. In step 1150, the mobile transport returns to the centralized factory to pick up a new solar table to repeat the automatic solar table landing and securement process until all solar tables are installed.

### B. Embodiments of Automatic Solar Table Transfer and Landing

Described hereinafter are systems and methods for automatic solar table transfer and landing for improved transportation and installation efficiency. A lander vehicle fetches a solar table from a mobile transport and lands the solar table at a point of installation. Solar table transfer and landing may be performed automatically. In such implementation, the mobile transport may be configured with a simplified hardware structural focused on autonomous solar table delivery, while the lander vehicle may be designated for solar table fetching and landing. As a result, overall installation efficiency may be significantly improved.

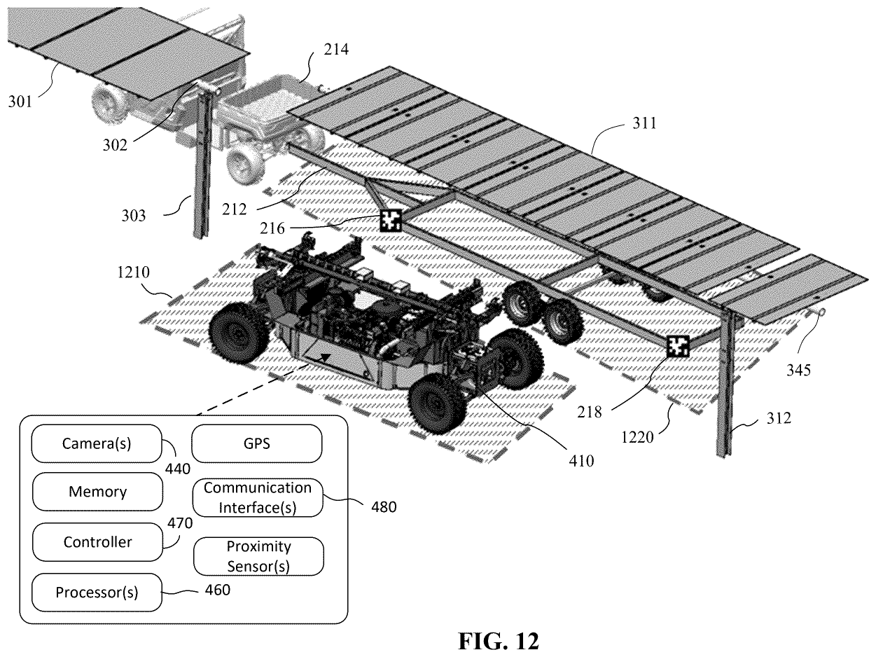

FIG. 12 depicts a perspective view of a lander unloading a solar table from a mobile transport at a point of installation according to various embodiments of the present invention. The mobile transport may be a trailer 212 towed by a powered vehicle 214 for hauling an assembled solar table 311. The trailer 212 may be parked next to a point of installation in between two piles 303 and 312, awaiting the lander vehicle 410 to pick up the solar table 311. When the lander vehicle 410 approaches the point of installation, the lander vehicle 410 needs to be parked within a lander parking zone 1210 to allow the lander vehicle 410 to fetch the solar table 311 and allow maneuverability of the solar table within an adjustment range of the lander vehicle 410 for successful solar table landing. The adjustment range may comprise operation ranges of the pair of support rails 411, the pair of sliding rails 412, and/or the pair of vertical motion elements 414. The lander parking zone is defined as a spatial zone where the lander vehicle can pick up the table from the transport vehicle and land it on adjacent piles 303 and 312.

The lander vehicle 410 may comprise one or more cameras or 3D scanners 440 to capture ambient 3D images, a GPS sensor 450 for vehicle positioning, a communication interface to enable wireless communication for remote control, control software update, etc., one or more proximity sensors deployed around the lander vehicle to detect objects nearby for vehicle maneuver safety at the point of installation, a controller to position and align the solar table within a three-dimensional space as well as control angular movement to facilitate manual/automatic solar table landing, a memory to store non-volatile instructions executable by the controller. The lander parking zone 1210 may be determined based on ambient 3D images, infrastructure information of the solar system, parameters of the lander vehicle, and a transport parking zone 1220.

Both the lander and the transporter parking zones may be determined by the presence of the transporter and lander vehicle positions, should they already be in position. It shall be noted that the determination of the lander parking zone 1210 may be performed locally using the on-board processor 460 on the lander vehicle 410. Alternatively, the lander vehicle 410 may transmit scanned 3D images via a communication interface 480 (e.g., a Wi-Fi or cellular communication interface) to a cloud for cloud computing or to an edge device for edge computing to determine the lander parking zone 1210 and transmit the determined result back to the lander vehicle. In case a lander parking zone cannot be determined due to terrain restrictions (e.g., obstacles, existence of debris materials, etc.), incorrectly installed piles, or the mobile transport being parked off-center beyond a threshold, the lander vehicle, the cloud, or the edge device may send an alert message to an on-site manager for attention and intervene. Once the lander parking zone 1210 is identified, the controller 470 may then control the lander vehicle 410 to park autonomously or manually within the lander parking zone, and may further control the support rails 411, sliding rails 412, and/or the vertical motion elements 414 to perform solar table transferring and installation.

In one or more embodiments, one or more AprilTags 216/218 or similar fiducial markers are placed on the mobile transporter, e.g., placed on a front end and a back end of the trailer 212. The April Tags 216/218 are scanned by the cameras or 3D scanners 440 for positioning of the trailer 212 to determine the transport parking zone 1220. It shall be understood that the first and second piles and an open end of a previously installed solar table/torque tube may also be used for the sensor to find correct location. Alternatively, the scanners and/or cameras may also be used to recognize/identify different features on piles, torque tubes, lander and transport vehicles to determine the vehicle and solar table's positions and path for installation. AI/machine learning algorithms may be used to identify the features found on the images to determine the required paths of the vehicle and solar table in order to facilitate a successful solar table transfer and/or landing. The AI model may be pre-trained in various scenarios to identify pertinent features and components. For example, the AI model deployed on a lander vehicle may be trained to identify trailer corners of a trailer with or without a solar table load in various locations in one or more solar power construction sites to locate the position of the trailer.

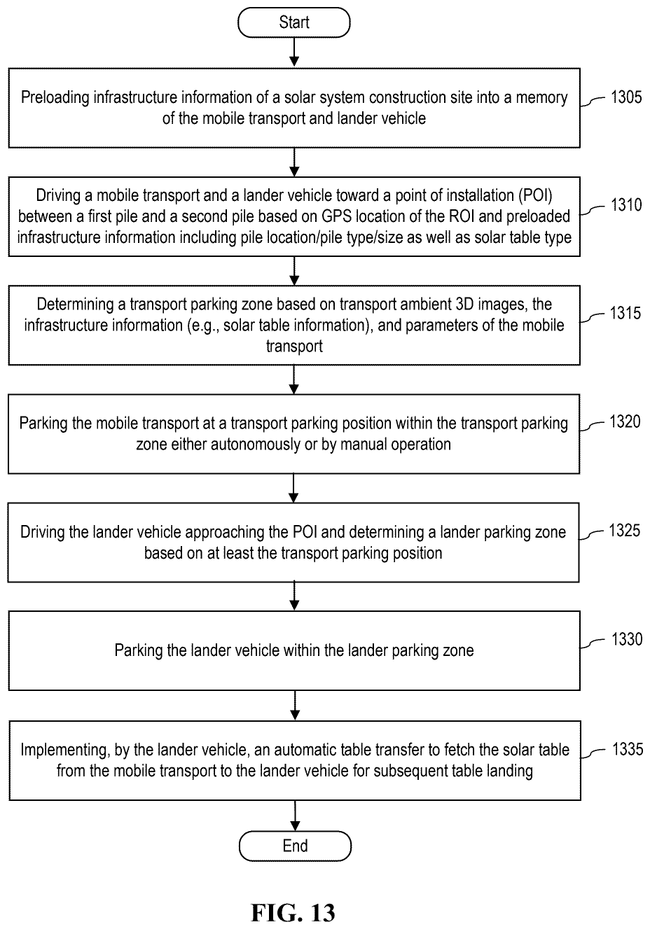

FIG. 13 is a progress diagram of a lander unloading a solar table at a point of installation from a mobile transport that arrives first according to various embodiments of the present invention. In step 1305, infrastructure information of the solar system construction site is preloaded into the memory within the lander vehicle and the mobile transport. The infrastructure information may comprise information of installed piles, e.g., pile numbers, inter-pile gap, pile height, pile orientation, pile dimensions, GPS location for each pile, etc., and solar table parameters, e.g., size, weight, torque tube specifications, torque end configuration, designed torque tube coupling depth for inter-tube connection, etc.

In step 1310, both the mobile transport and the lander vehicle are driven toward a point of installation between a first pile 303 (also referred to as a forward pile) and a second pile 312 (also referred to as an aft pile). The solar table fetching and landing task may be assigned to the lander vehicle automatically based on solar table transporting task to be performed by the mobile transport. The mobile transport may be driven or towed autonomously based on infrastructure information of the solar system construction site, and arrives earlier than the lander vehicle. Since the solar system site is under construction, driving routes within the construction site need to be planned according to the infrastructure information.

In step 1315, a transport parking zone is determined based on transport ambient three-dimensional (3D) images, the infrastructure information (e.g., solar table information), and parameters of the mobile transport, which may comprise size, height, and weight of the mobile transport, etc. The transport ambient 3D images may be obtained by using one or more on-board cameras and/or LIDAR sensors within the mobile transport to scan ambient environment of the point of installation. The transport parking zone is a spatial zone allowing the solar table to be fetched from the mobile transport directly for installation without needing further maneuvering parking position of the mobile transport.

In step 1320, the mobile transport is parked at a transport parking position within the transport parking zone, manually by an operator, by remote control, or by an autonomous positioning system that autonomously controls the mobile transport under guidance of one more onboard cameras and/or LIDAR sensors, and awaits the lander vehicle for solar table transferring. In the case of a manual operator driving the transporter to the transport parking position within the transport parking zone, the cameras and sensors can provide environmental awareness that can be used by the AI model to guide the operator to move the vehicle to the correct parking location. The method of guiding can be an image on a screen, audio or light.

In step 1325, the lander vehicle is driven approaching the toward the point of installation and a lander parking zone is determined based on at least the transport parking position. The lander parking zone is a spatial zone allowing the lander vehicle to pick up the solar table from the mobile transport and land the solar table on the first and second piles. In one or more embodiments, the lander vehicle uses one or more on-board cameras and/or LIDAR sensors to scan ambient environment of the point of installation and the transport parking position to generate lander ambient 3D images. The lander parking zone may be determined further based on the lander ambient 3D images, the infrastructure information (e.g., solar table information), and parameters of the lander vehicle, which may comprise weight of the lander vehicle, adjustment limits for horizonal, vertical, and side-shift movements and yaw/pitch/roll angle controls. The on-board cameras may comprise a stereo camera that uses two or more lenses with separate image sensors to perceive depth and generate the lander ambient 3D images around the point of installation. The lander ambient 3D images may comprise ground situation (flatness, slope, obstacles, etc.) in between the first pile 302 and the second pile 312, and information of the piles (height, distance, orientation, etc.).

The lander vehicle may identify one or more characteristics of the solar table, e.g., both ends of a torque tube, to locate the transport parking zone. In one or more embodiments, the lander vehicle may also be able to identify an orientation of the solar table by recognition of torque tube ends, e.g., a swaged end or an unswaged end.

For example, when the transport parking position of the mobile transport is off-center between the first pile 302 and the second pile 312, the lander parking zone might also be off-center accordingly to offset the deviation of the mobile transport for a stable and secure table transfer between the mobile transport and the lander vehicle. The off-center shift of the lander vehicle may be based on the actual deviation of the mobile transport, specification of the solar table, specification of the lander vehicle, and infrastructure information (e.g., inter-pile gap between the first pile 302 and the second pile 312).

In certain circumstances, the mobile transport may be parked off-center beyond a threshold (e.g., a solar table center having more than 3 feet longitudinally away from a center point between the first pile 302 and the second pile 312). As a result, the lander vehicle may not be able to determine a lander parking zone. In response to such situation, the lander vehicle sends a message to the mobile transport requesting shifting of the mobile transport. The message may comprise a desired shifting direction (forward or backward) and distance. Once the mobile transport finishes the shifting, the lander vehicle may implement scanning again to determine the transport parking zone and thus a lander parking zone accordingly. Such shifting-scanning-determining process may be iterated until a lander parking zone is able to be identified.

In another example, lander vehicle limits and weight of the solar table need to be taken into consideration when determining the lander parking zone for side-shift operation. A lander vehicle would have much less side-shift range with a heavyweight solar table load compared to with a lightweight solar table. In another example, the determination of the lander parking zone should take into consideration of the size of the solar table and the inter-pile gap to ensure that the mobile transport can move the solar table adequately to a previously installed solar table. Parking within the lander parking zone enables the lander vehicle to safely perform solar table fetching and subsequent solar table landing operations.

In one or more embodiment, the lander parking zone needs to meet forward and backward parking tolerance (e.g., ±7.5″ clearance with respect to the first or second pile), lander wheel tolerance (e.g., 6-8″ away from the piles such that the lander vehicle does not need to weave in or out of the piles).

In step 1330, the lander vehicle is parked within the lander parking zone, manually by an operator, by remote control, or by an autonomous positioning system that autonomously controls the lander vehicle under guidance of one more onboard cameras and/or LIDAR sensors, for solar table transferring and landing. In a semi-autonomous or supervised autonomous system, an operator may supervise the lander vehicle to park within the lander parking zone. For the autonomy case, the lander vehicle may be guided to maneuver into lander parking zone. In the case of a manual operator driving the lander to park within the lander parking zone, the onboard cameras and/or sensors can provide environmental awareness that can be used by the AI model to guide the operator to move the vehicle to the correct parking location. The method of guiding can be an image on a screen, audio or light. In step 1335, once the lander vehicle is parked in the lander parking zone, the lander vehicle implements an automated table transfer to fetch the solar table from the mobile transport to the lander vehicle for subsequent table landing.

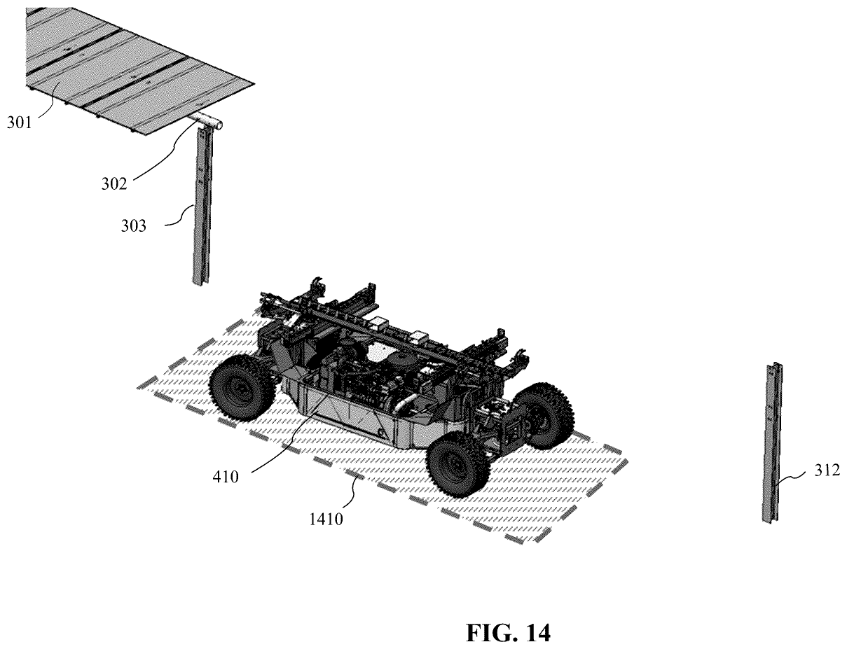

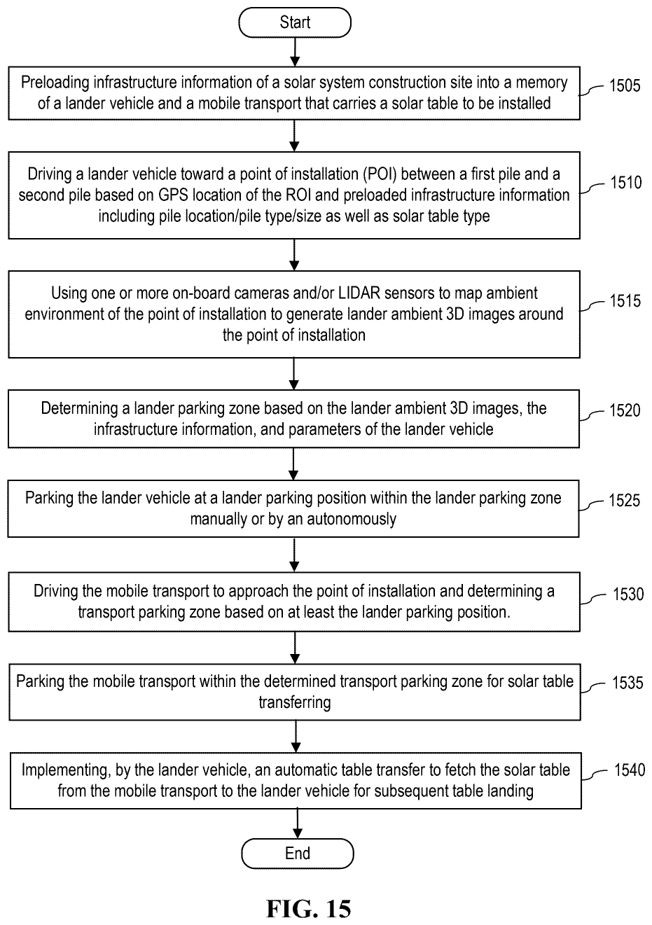

In one or more embodiments, the lander vehicle may arrive at the point of installation before the mobile transport, as shown in FIG. 14. In this situation, the lander vehicle may need to park first, and the parking position of the lander vehicle will be determined in absence of a transport parking position. FIG. 15 depicts a progress diagram in this circumstance of a lander parking at a point of installation, awaiting a mobile transport, and unloading a solar table from the mobile transport according to various embodiments of the present invention. In step 1505, infrastructure information of the solar system construction site is preloaded into the memory within a lander vehicle and a mobile transport that carries a solar table to be installed. The infrastructure information may comprise information of installed piles, e.g., pile numbers, inter-pile gap, pile height, pile orientation, pile dimensions, GPS location for each pile, etc., and solar table parameters, e.g., size, weight, torque tube specifications, torque end configuration, designed torque tube coupling depth for inter-tube connection, etc.

In step 1510, the lander vehicle is driven toward a point of installation between a first pile and a second pile in a solar system construction site for a task of fetching and landing a solar table. The lander vehicle may be driven or towed autonomously based on GPS location and infrastructure information of the solar system construction site. Since the solar system site is under construction, driving routes within the construction site need to be planned according to the infrastructure information.

In step 1515, the lander vehicle uses one or more on-board cameras and/or LIDAR sensors to map ambient environment of the point of installation to generate lander ambient 3D images around the point of installation. The lander vehicle may identify the first pile and the second pile locations, an end of a previously installed solar table (torque tube) or slew drive, as well as fastener holes and BHA brackets.

In step 1520, the lander vehicle determines a lander parking zone 1410 based on the lander ambient 3D images, the infrastructure information (e.g., solar table information), and parameters of the lander vehicle, which may comprise weight of the lander vehicle, adjustment limits for horizonal, vertical, and side-shift movements and yaw/pitch/roll angle controls.

In step 1525, the lander vehicle is parked at a lander parking position within the lander parking zone, manually by an operator, by remote control, or by an autonomous positioning system that autonomously controls the lander vehicle.

In step 1530, the mobile transport is driven to approach the point of installation and determines a transport parking zone based on at least the lander parking position. The transport parking zone is a spatial zone allowing the solar table to be fetched from the mobile transport directly for installation without needing further maneuvering parking position of the mobile transport. In one or more embodiments, the mobile transport uses one or more on-board cameras or LIDAR sensors to scan ambient environment of the point of installation and the lander parking position to generate transport ambient 3D images. The transport parking zone may be determined further based on the transport ambient 3D images, the infrastructure information (e.g., solar table information), and parameters of the mobile transport, which may comprise size and weight of the mobile transport. The on-board cameras may comprise a stereo camera that uses two or more lenses with separate image sensors to perceive depth and generate the transport ambient 3D images around the point of installation. The transport ambient 3D images may comprise ground situation (flatness, slope, obstacles, etc.) in between the first pile 302 and the second pile 312, and information of the piles (height, distance, orientation, etc.), ambient 3D images around the point of installation, infrastructure information of the solar system construction site, and the lander parking position. Similar to the lander vehicle, the mobile transport may comprise one or more on-board cameras or LIDAR sensors that scan ambient environment of the point of installation and the lander vehicle to identify the lander parking zone and to generate the ambient 3D images around the point of installation.

In step 1535, the mobile transport parks within the determined transport parking zone for solar table transferring. In step 1540, the lander vehicle implements an automated table transfer to fetch the solar table from the mobile transport to the lander vehicle for subsequent table landing.

The lander vehicle 410 may implement an automatic solar table landing in a process similar to the solar table landing process by a mobile transport as disclosed in Section A Embodiments of Automatic Solar Table Landing. The lander vehicle 410 may be controlled to raise, lower, tilt, roll, rotate, and/or sideshift the fetched solar table 311 for installation on adjacent piles 303 and 312.

### C. Computing System Embodiments

In one or more embodiments, aspects of the present patent document may include, or may be implemented on one or more computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), Programmable Logic Controller (PLC), tablet computer, mobile device (e.g., personal digital assistant (PDA), smartphone, phablet, tablet, etc.), smartwatch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

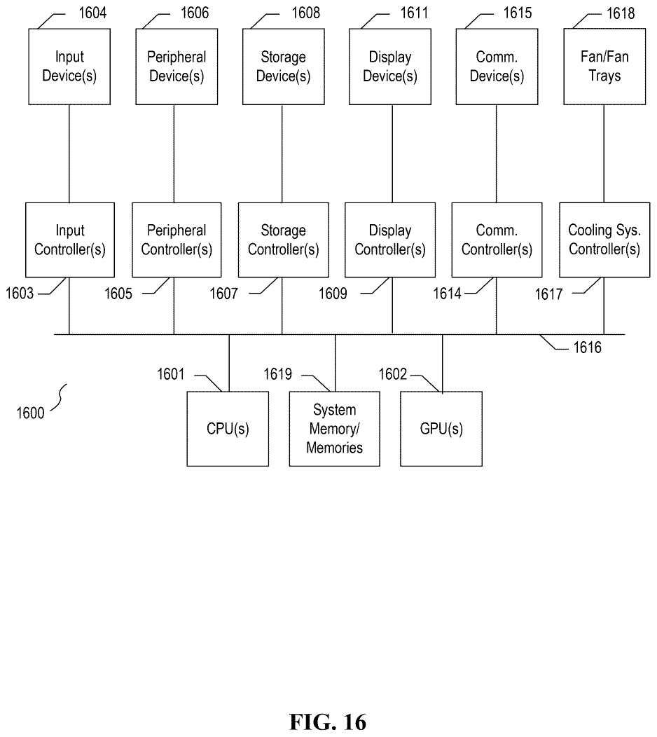

FIG. 16 shows a simplified block diagram of a computing system in accordance with various embodiments of the invention. It will be understood that the functionalities shown for system 1600 may operate to support various embodiments of a computing system—although it shall be understood that a computing system may be differently configured and include different components, including having fewer or more components as depicted in FIG. 16.

As illustrated in FIG. 16, the computing system 1600 includes one or more CPUs 1601 that provide computing resources and control the computer. CPU 1601 may be implemented with a microprocessor or the like and may also include one or more graphics processing units (GPU) 1602 and/or a floating-point coprocessor for mathematical computations. In one or more embodiments, one or more GPUs 1602 may be incorporated within the display controller 1609, such as part of a graphics card or cards. The system 1600 may also include a system memory 1619, which may comprise RAM, ROM, or both.

A number of controllers and peripheral devices may also be provided, as shown in FIG. 16. An input controller 1603 represents an interface to various input device(s) 1604. The computing system 1600 may also include a storage controller 1607 for interfacing with one or more storage devices 1608 each of which includes a storage medium such as magnetic tape or disk, or an optical medium that might be used to record programs of instructions for operating systems, utilities, and applications, which may include embodiments of programs that implement various aspects of the present disclosure. Storage device(s) 1608 may also be used to store processed data or data to be processed in accordance with the disclosure. The system 1600 may also include a display controller 1609 for providing an interface to a display device 1611, which may be a cathode ray tube (CRT) display, a thin film transistor (TFT) display, organic light-emitting diode, electroluminescent panel, plasma panel, or any other type of display. The computing system 1600 may also include one or more peripheral controllers or interfaces 1605 for one or more peripherals 1606. Examples of peripherals may include one or more printers, scanners, input devices, output devices, sensors, and the like. A communications controller 1614 may interface with one or more communication devices 1615, which enables the system 1600 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1600 comprises one or more fans or fan trays 1618 and a cooling subsystem controller or controllers 1617 that monitors thermal temperature(s) of the system 1600 (or components thereof) and operates the fans/fan trays 1618 to help regulate the temperature.

In the illustrated system, all major system components may connect to a bus 1616, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable media including, for example: magnetic media such as hard disks, floppy disks, and magnetic tape; optical media such as compact discs (CDs) and holographic devices; magneto-optical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It should be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented as a whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize that no computing system or programming language is critical to the practice of the present disclosure. One skilled in the art will also recognize that a number of the elements described above may be physically and/or functionally separated into modules and/or sub-modules or combined together.

It will be appreciated by those skilled in the art that the preceding examples and embodiments are exemplary and not limited to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claim may be arranged differently including having multiple dependencies, configurations, and combinations.

What is claimed is:

1. A method for solar table transferring and landing, the method comprising:
driving a lander vehicle toward a point of installation between a first pile and a second pile at a solar system construction site, wherein a mobile transport is parked at a transport parking position next to the point of installation with a load of a solar table to be transferred to the lander vehicle, the solar table comprises a torque tube and multiple solar modules secured onto the torque tube;
scanning, using one or more on-board cameras or light detection and ranging (LIDAR) sensors on the lander vehicle, ambient environment of the point of installation and the mobile transport to generate ambient 3D images around the point of installation; and
determining a lander parking zone based on the ambient 3D images, infrastructure information of the solar system construction site, the transport parking position, and parameters of the lander vehicle, the lander parking zone is a spatial zone allowing the lander vehicle to pick up the solar table from the mobile transport and land the solar table on the first and second piles.

2. The method of claim 1 further comprising:
parking the lander vehicle within the lander parking zone for solar table transferring and landing.

3. The method of claim 2 further comprising:
implementing, by the lander vehicle, an automatic table transfer to fetch the solar table from the mobile transport for table landing.

4. The method of claim 1, wherein the infrastructure information of the solar system construction site is preloaded into a memory within the lander vehicle, the infrastructure information comprises one or more of:
information of installed piles comprising one or more of:
pile numbers;
inter-pile gap;
pile height;
pile size;
pile orientation; and
Global Positioning System (GPS) location for each pile; and solar table parameters comprising one or more of:
size and/or weight of one or more solar tables to be installed within the solar system construction site;
torque tube specifications of the one or more solar tables;
torque end configuration of each torque tube; and
designed torque tube coupling depth for inter-tube connection.

5. The method of claim 2, wherein the lander vehicle is parked within the lander parking zone manually, by remote control, or by an autonomous positioning system that autonomously controls the lander vehicle.

6. The method of claim 1, wherein the mobile transport is a trailer.

7. The method of claim 1, further comprising:
in response to the mobile transport being parked off-center beyond a threshold, sending, from the lander vehicle, a message to the mobile transport requesting shifting of the mobile transport.

8. The method of claim 7, wherein the message comprises a desired shifting direction and distance.

9. The method of claim 1, wherein in response to the mobile transport being parked off-center between the first pile and the second pile, the lander parking zone is off-center accordingly to offset a deviation of the mobile transport.

10. A system for solar table transferring and landing, the system comprising:
a mobile transport that transports a solar table and parks at a transport parking position next to a point of installation between a first pile and a second pile at a solar system construction site, the solar table comprising a torque tube and multiple solar modules secured onto the torque tube; and
a lander vehicle that is driven toward the point of installation, the lander vehicle comprises one or more on-board cameras or light detection and ranging (LIDAR) sensors that scan ambient environment of the point of installation and the mobile transport to generate ambient 3D images around the point of installation, the lander vehicle determines a lander parking zone based on the ambient 3D images, infrastructure information of the solar system construction site, the transport parking position, and parameters of the lander vehicle, the lander parking zone is a spatial zone allowing the lander vehicle to pick up the solar table from the mobile transport and land the solar table on the first and second piles.

11. The system of claim 10, wherein once the lander parking zone is determined, the lander vehicle parks within the lander parking zone for solar table transferring and landing.

12. The system of claim 11, wherein once the lander vehicle parks within the lander parking zone, the lander vehicle implements an automatic table transfer to fetch the solar table from the mobile transport for table landing.

13. The system of claim 11, wherein the lander vehicle is parked within the lander parking zone manually, by remote control, or by an autonomous positioning system that autonomously controls the lander vehicle.

14. The system of claim 10, wherein the mobile transport is a trailer.

15. The system of claim 10, wherein:
in response to the mobile transport being parked off-center beyond a threshold, the lander vehicle sends a message to the mobile transport requesting shifting of the mobile transport.

16. The system of claim 15, wherein the message comprises a desired shifting direction and distance.

17. A method for solar table transferring and landing, the method comprising:
parking a lander vehicle at a lander parking position within a lander parking zone next to a point of installation between a first pile and a second pile at a solar system construction site;
driving a mobile transport that carries a solar table to approach the point of installation, the solar table comprising a torque tube and multiple solar modules secured onto the torque tube;
determining a transport parking zone based on ambient 3D images around the point of installation, infrastructure information of the solar system construction site, and the lander parking position, the transport parking zone is a spatial zone allowing the solar table to be fetched by the lander vehicle from the mobile transport;
parking the mobile transport within the transport parking zone; and
implementing, by the lander vehicle, an automatic table transfer to fetch the solar table from the mobile transport for table landing.

18. The method of claim 17, wherein the mobile transport is a trailer.

19. The method of claim 17, wherein the lander parking zone is determined by the lander vehicle based on ambient 3D images around the point of installation, the infrastructure information, and parameters of the lander vehicle.

20. The method of claim 19, wherein the infrastructure information of the solar system construction site is preloaded into a memory within the lander vehicle.
